(19) United States
(12) Patent Application Publication
(10) Pub. No.: US 2021/0008904 A1
(43) Pub. Date: Jan. 14, 2021

(54) CUTTER DEVICE AND PRINTING APPARATUS

(71) Applicant: SEIKO EPSON CORPORATION, Tokyo (JP)

(72) Inventors: Hiroaki SAKAJO, MATSUMOTO-SHI (JP); Koji YAMADA, OKAYA-SHI (JP)

(21) Appl. No.: 16/923,643

(22) Filed: Jul. 8, 2020

(30) Foreign Application Priority Data
Jul. 11, 2019 (JP) 2019-129308

(51) Int. Cl. B41J 11/70; B26D 1/20; B26D 1/06

(52) U.S. Cl. CPC B41J 11/706; B26D 5/007; B26D 1/065; B26D 1/205

(57) ABSTRACT

A cutter device including a transport unit for transporting a medium, a round blade configured to move in a width direction while rotating, and a fixed blade provided along the width direction, in which a rotation direction in which the round blade rotates when the medium is cut by causing the round blade to move to a first direction of the width direction coincides with the first direction, a rotational speed at which the round blade rotates when the medium is cut by causing the round blade to move to the first direction is set greater than a speed at which the round blade is caused to move to the first direction, and a thickness of the round blade is not less than 1 mm.

The present application is based on, and claims priority from JP Application Serial Number 2019-129308, filed Jul. 11, 2019, the disclosure of which is hereby incorporated by reference herein in its entirety.

### BACKGROUND

### 1. Technical Field

The disclosure relates to a cutter device and a printing apparatus.

### 2. Related Art

In the related art, a cutter device is used for cutting a medium while clamping the medium with a fixed blade and a round blade, and causing the round blade to move relative to the fixed blade. For example, JP 11-226894 A discloses a cutter for an adhesive sheet for cutting an adhesive sheet by causing a rotating blade being a round blade to move relative to a fixed blade.

However, in a cutter device in the related art, which is as described in JP 11-226894 A, for cutting a medium by causing the round blade to move relative to a fixed blade, the medium may be pushed, in a movement direction in which the round blade moves, to displace the position of the medium at the time when causing the round blade to move relative to the fixed blade to cut the medium. This is because the round blade may be caused to move when cutting the medium to allow the round blade to push the medium in the movement direction in which the round blade moves to be displaced from a predetermined position. The displacement of the position of the medium may lead to a displacement of a cutting position of the medium, or the like. Note that it is conceivable to form a member for pressing the medium in order to suppress the position of the medium from being displaced, however, such a member may not be able to be configured due to the reason that there is no margin in an internal space of the cutter device, the occurrence of cost increases, or the like.

### SUMMARY

A cutter device according to a first aspect of the present disclosure for resolving the above-described issue includes a transport unit for transporting a medium, a round blade configured to move, while rotating, in a width direction intersecting a transport direction in which the medium is transported, and a fixed blade provided along the width direction, in which a rotation direction in which the round blade rotates when the medium is cut by causing the round blade to move to a first direction of the width direction coincides with the first direction, a rotational speed at which the round blade rotates when the medium is cut by causing the round blade to move to the first direction is set greater than a speed at which the round blade is caused to move to the first direction, and a thickness of the round blade is not less than 1 mm.

### BRIEF DESCRIPTION OF THE DRAWINGS

FIG. 1 is a schematic side cross-sectional view of a printing apparatus according to an example of the present disclosure.

FIG. 2 is a block diagram illustrating an electrical configuration of a printing apparatus according to an example of the present disclosure.

FIG. 3 is a schematic side cross-sectional view of a cutter unit of a printing apparatus according to an example of the present disclosure.

FIG. 4 is a schematic perspective view of a cutter unit of a printing apparatus according to an example of the present disclosure.

FIG. 5 is a schematic perspective view of a round blade carriage of a cutter unit of a printing apparatus according to an example of the present disclosure.

FIG. 6 is a schematic perspective view of a round blade carriage of a cutter unit of a printing apparatus according to an example of the present disclosure, which is viewed from a direction different from that of FIG. 5.

FIG. 7 is a schematic perspective view of a round blade of a cutter unit of a printing apparatus according to an example of the present disclosure.

FIG. 8 is a schematic perspective view of a fixed blade of a cutter unit of a printing apparatus according to an example of the present disclosure.

FIG. 9 is a schematic view of a cutter unit for describing a cutting angle formed by a round blade and a fixed blade.

FIG. 10 is a schematic perspective view for describing a driving of a printing apparatus according to an example of the present disclosure, which illustrates a state immediately prior to cutting of a medium.

FIG. 11 is a schematic perspective view for describing a driving of a printing apparatus according to an example of the present disclosure, which illustrates a state immediately after cutting of a medium.

### DESCRIPTION OF EXEMPLARY EMBODIMENTS

First, the present disclosure will be schematically described.

A cutter device according to a first aspect of the present disclosure for resolving the above-described issue includes a transport unit for transporting a medium, a round blade configured to move, while rotating, in a width direction intersecting a transport direction in which the medium is transported, and a fixed blade provided along the width direction, in which a rotation direction in which the round blade rotates when the medium is cut by causing the round blade to move to a first direction of the width direction coincides with the first direction, a rotational speed at which the round blade rotates when the medium is cut by causing the round blade to move to the first direction is set greater than a speed at which the round blade is caused to move to the first direction, and a thickness of the round blade is not less than 1 mm.

According to the above aspect, the round blade is caused to rotate to have a force applied to the medium in the rotation direction in which the round blade rotates, and the rotational speed at which the round blade rotates is made to coincide with a rotational speed at which the medium is drawn toward the round blade at a speed that is greater than a speed at which the medium is pushed in a movement direction in which the round blade moves in conjunction with a movement of the round blade. Then, by setting the thickness of the round blade to not less than 1 mm, a contact area between the round blade and the medium can be enlarged, making it possible to sufficiently strengthen a force applied in a direction opposite to a force pressing the medium in the movement direction in which the round blade moves. This makes it possible, when the round blade is caused to move relative to the fixed blade to cut the medium, to suppress the position of the medium from being displaced due to the medium being pressed in the movement direction in which the round blade moves.

A cutter device according to a second aspect of the present disclosure includes a transport unit for transporting a medium, a round blade configured to move, while rotating, in a width direction intersecting a transport direction in which the medium is transported, and a fixed blade provided along the width direction, in which a rotation direction in which the round blade rotates when the medium is cut by causing the round blade to move to a first direction in the width direction coincides with the first direction, where a side of the round blade opposite to a side on which the round blade comes in contact with the medium coincides with a direction moving to the first direction, a rotation speed at which the round blade rotates when the medium is cut by causing the round blade to move to the first direction is set greater than a speed at which the round blade is caused to move to the first direction, and a rake angle of the round blade is not less than 70 degrees.

According to the above aspect, the round blade is caused to rotate to have a force applied to the medium in the rotation direction in which the round blade rotates, and the rotational speed at which the round blade rotates is made to coincide with a rotational speed at which the medium is drawn toward the round blade at a speed that is greater than a speed at which the medium is pushed in a movement direction in which the round blade moves in conjunction with a movement of the round blade. Then, by setting the rake angle of the round blade to not less than 70 degrees, a contact area between the round blade and the medium can be enlarged, making it possible to sufficiently strengthen a force applied in a direction opposite to a force pressing the medium in the movement direction in which the round blade moves. This makes it possible, when the round blade is caused to move relative to the fixed blade to cut the medium, to suppress the position of the medium from being displaced due to the medium being pressed in the movement direction in which the round blade moves.

A cutter device according to a third aspect of the present disclosure is a cutter device in which in the second aspect, a thickness of the round blade is not less than 1 mm.

According to the above aspect, by setting the rake angle of the round blade to not less than 70 degrees and the thickness of the round blade to not less than 1 mm, the contact area between the round blade and the medium can be specifically enlarged. This makes it possible, when the round blade is caused to move relative to the fixed blade to cut the medium, to suppress, in a particularly efficient manner, the position of the medium from being displaced due to the medium being pressed in the movement direction in which the round blade moves.

A cutter device according to a fourth aspect of the present disclosure is a cutter device in which in any one of the first to third aspects, a thickness of the fixed blade is not less than 1 mm.

According to the above aspect, by setting the thickness of the fixed blade to not less than 1 mm, the medium can be effectively pressed toward a direction opposite to the movement direction in which the round blade moves, in a tangential direction at a contact point between the round blade and the medium. This makes it possible, when the round blade is caused to move relative to the fixed blade to cut the medium, to suppress, in a particularly efficient manner, the position of the medium from being displaced due to the medium being pressed in the movement direction in which the round blade moves.

A cutter device according to a fifth aspect of the present disclosure is a cutter device in which in any one of the first to fourth aspects, a rake angle of the fixed blade is not less than 70 degrees.

According to the above aspect, by setting the rake angle of the fixed blade to not less than 70 degrees, the medium can be effectively pressed toward a direction opposite to the movement direction in which the round blade moves, in a tangential direction at a contact point between the round blade and the medium. This makes it possible, when the round blade is caused to move relative to the fixed blade to cut the medium, to suppress, in a particularly efficient manner, the position of the medium from being displaced due to the medium being pressed in the movement direction in which the round blade moves.

A printing apparatus according to a sixth aspect of the present disclosure includes a transport unit for transporting a medium, a printing unit configured to perform printing on the medium, a round blade configured to move, while rotating, in a width direction intersecting a transport direction in which the medium is transported, and a fixed blade provided along the width direction, in which a rotation direction in which the round blade rotates when the medium is cut by causing the round blade to move to a first direction of the width direction coincides with the first direction, a rotational speed at which the round blade rotates when the medium is cut by causing the round blade to move to the first direction is set greater than a speed at which the round blade is caused to move to the first direction, and a thickness of the round blade is not less than 1 mm.

According to the above aspect, the round blade is caused to rotate to have a force applied to the medium in the rotation direction in which the round blade rotates, and the rotational speed at which the round blade rotates is made to coincide with a rotational speed at which the medium is drawn toward the round blade at a speed that is greater than a speed at which the medium is pushed in a movement direction in which the round blade moves in conjunction with a movement of the round blade. Then, by setting the thickness of the round blade to not less than 1 mm, a contact area between the round blade and the medium can be enlarged, making it possible to sufficiently strengthen a force applied in a direction opposite to a force pressing the medium in the movement direction in which the round blade moves. This makes it possible, when the round blade is caused to move relative to the fixed blade to cut the medium, to suppress the position of the medium from being displaced due to the medium being pressed in the movement direction in which the round blade moves. This makes it possible to suppress an image from being printed at a position displaced from a desired position on the medium.

A printing apparatus according to a seventh aspect of the present disclosure includes a transport unit for transporting a medium, a printing unit configured to perform printing on the medium, a round blade configured to move, while rotating, in a width direction intersecting a transport direction in which the medium is transported, and a fixed blade provided along the width direction, in which a rotation direction in which the round blade rotates when the medium is cut by causing the round blade to move to a first direction of the width direction coincides with the first direction, a rotation speed at which the round blade rotates when the medium is cut by causing the round blade to move to the first direction is set greater than a speed at which the round blade is caused to move to the first direction, and a rake angle of the round blade is not less than 70 degrees.

According to the above aspect, the round blade is caused to rotate to have a force applied to the medium in the rotation direction in which the round blade rotates, and the rotational speed at which the round blade rotates is made to coincide with a rotational speed at which the medium is drawn toward the round blade at a speed that is greater than a speed at which the medium is pushed in a movement direction in which the round blade moves in conjunction with a movement of the round blade. Then, by setting the rake angle of the round blade to not less than 70 degrees, a contact area between the round blade and the medium can be enlarged, making it possible to sufficiently strengthen a force applied in a direction opposite to a force pressing the medium in the movement direction in which the round blade moves. This makes it possible, when the round blade is caused to move relative to the fixed blade to cut the medium, to suppress the position of the medium from being displaced due to the medium being pressed in the movement direction in which the round blade moves. This makes it possible to suppress an image from being printed at a position displaced from a desired position on the medium.

Hereinafter, embodiments according to the present disclosure will be described with reference to the accompanying drawings.

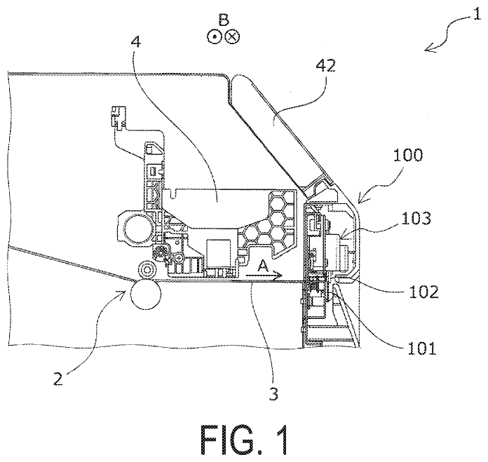

First, an overview of a printing apparatus 1 according to an example of the present disclosure will be described with reference to FIG. 1. Here, the printing apparatus 1 of the example includes a cutter unit 100, which can be expressed as a cutter device as well.

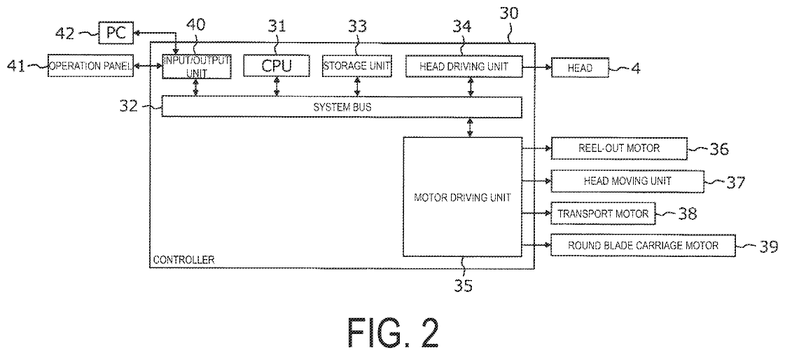

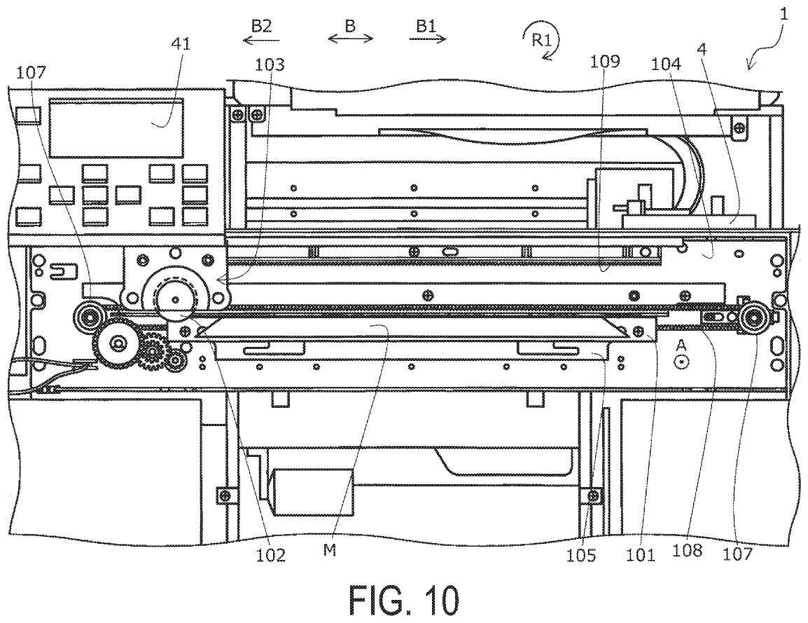

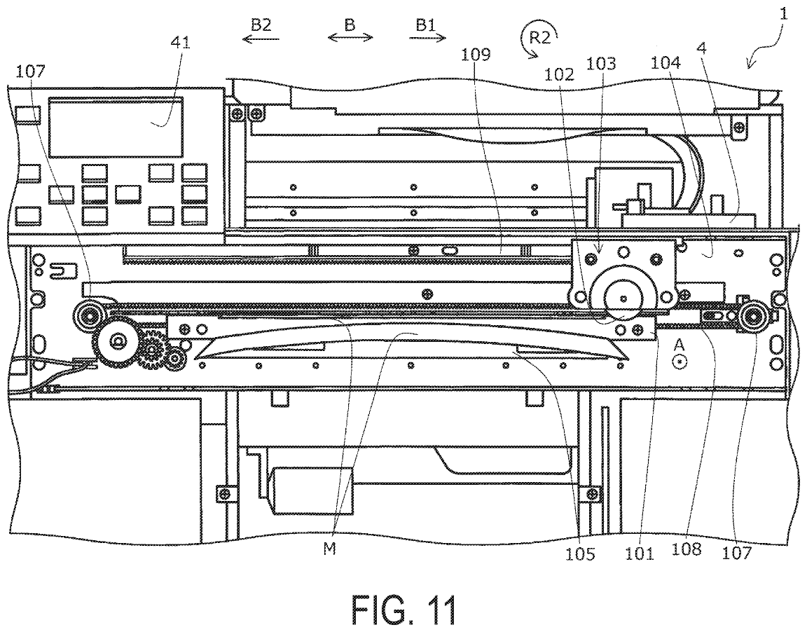

The printing apparatus 1 of the example is a printing apparatus configured to print an image on a medium M (see FIGS. 10 and 11) containing an adhesive, such as a sticker or label paper, and is communicably coupled to a computer (PC 42: see FIG. 2), which is an external device. Note that the printing apparatus 1 of the example is configured to perform printing on the medium M that is wound in a rolled form, and may also be configured to perform printing on the medium M of a single-sheet type, such as a cut paper.

As illustrated in FIG. 1, the printing apparatus 1 of the example includes a roller pair 2 as a transport unit that transports the medium M, and is configured to transport the medium M, over a platen 3, along a transport direction A. The transport unit of the example is a roller pair that transports the medium M while clamping the medium M with two rollers opposing to each other, however, the configuration of the transport unit is not limited to the roller pair.

The transport unit also includes, at a position facing the platen 3, a head 4 that discharges an ink onto the medium M being transported along the transport direction A. In other words, the head 4 serves as a printing unit configured to form an image on the medium M. The head 4 of the example is configured to discharge an ink onto the medium M while reciprocally moving in a width direction B that intersects the transport direction A. That is, the printing apparatus 1 of the example can repeat transporting the medium M in the transport direction A by a predetermined transport amount and causing a head 19 to discharge an ink while causing the head 19 to move in the width direction B in a state of stopping the medium M, to form a desired image on the medium M.

Note that the printing apparatus 1 of the example is a so-called serial printer configured to alternately repeat transporting the medium M by a predetermined transport amount and causing the head 19 to reciprocatively move to perform printing, however, the printing apparatus 1 may also be a so-called line printer configured to continuously perform printing using a line head formed with nozzles in a line shape along the width direction B of the medium M, while continuously transporting the medium M. The printing apparatus may further be a printing apparatus including a printing unit having a configuration different from that of a so-called printing unit of an ink jet scheme that is configured to discharge an ink to perform printing.

The cutter unit 100 is provided downstream of the head 4 in the transport direction A. The cutter unit 100 will be described in detail later, however, the cutter unit 100 includes a fixed blade 101 extending along the width direction B, and a round blade carriage 103 including a round blade 102 configured to move along the fixed blade 101 while being in contact with the fixed blade 101. The printing apparatus 1 of the example is configured to cause the cutter unit 100 to cut the medium M along the width direction B at a desired position.

Next, the electrical configuration of the printing apparatus 1 of the example will be described with reference to FIG. 2.

A controller 30 includes a CPU 31 configured to manage control of the entirety of the printing apparatus 1. The CPU 31 is coupled via a system bus 32 to a storing unit 33 that includes a ROM that stores, for example, various types of control programs to be implemented by the CPU 31, and a RAM, an EEPROM, and the like that are configured to temporarily store data.

The CPU 31 is also coupled via the system bus 32 with a head driving unit 34 for driving the head 4 to cause the head 4 to discharge an ink.

The CPU 31 is also coupled via the system bus 32 with a motor driving unit 35 that is coupled to a reel-out motor 36, a head moving motor 37, a transport motor 38, and a round blade carriage motor 39. Here, the reel-out motor 36, which is a rotation mechanism at a set portion of the medium M that is wound into a rolled form, serves as a motor that drives the set portion to transport the medium M wound into a rolled form to the roller pair 2. Also, the head moving motor 37 serves as a motor for causing the head 4 to reciprocatively move in the width direction B. In addition, the transport motor 38 serves as a motor for causing the roller pair 2 to rotate. Further, the round blade carriage motor 39 serves as a motor for causing the round blade carriage 103 to move along the width direction B.

Moreover, the CPU 31 is coupled, via an input/output unit 40, with an operating panel 41 configured to accept commands via the system bus 32 from a user such as an input of data from the user, and a PC 42 for sending and receiving data such as image data, and signals.

The controller 30, which is configured as such, can perform controlling of the entirety of each of the constituent members of the printing apparatus 1 of the example, such as the set portion of the medium M that is wound into a rolled form, the roller pair 2, the head 4, and the round blade carriage 103.

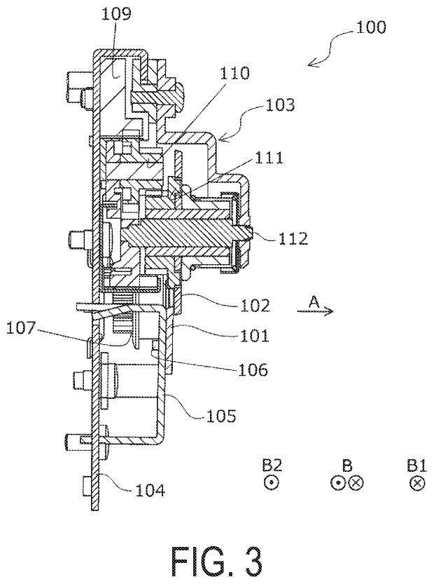

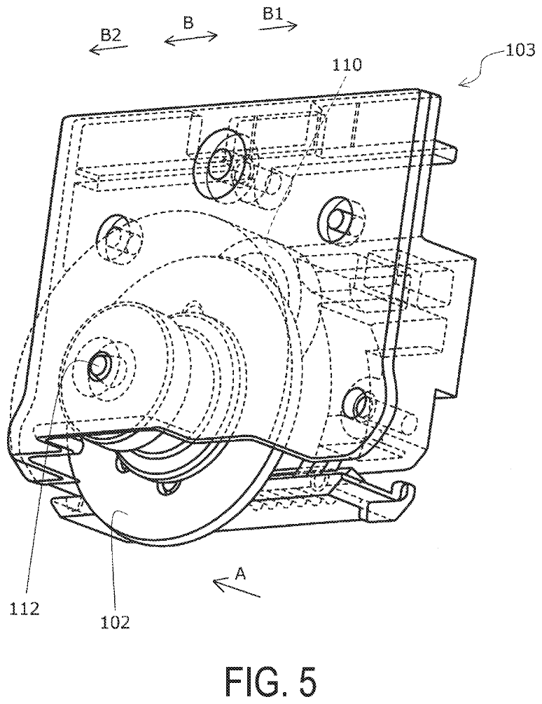

Next, a detailed configuration of the cutter unit 100, which is a main part of the printing apparatus 1 of the example, will be described with reference to FIGS. 3 to 9.

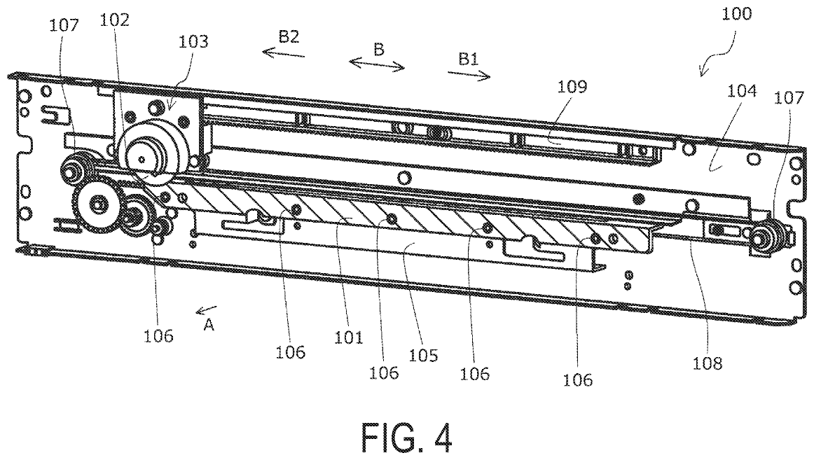

As illustrated in FIGS. 3 and 4, the cutter unit 100 includes a frame 104 extending in the width direction B, where the frame 104 is provided with an attachment portion 105 of the fixed blade 101. The fixed blade 101 is fixed to the attachment portion 105 by a screw 106.

Further, as illustrated in FIG. 4, the frame 104 is provided with two pulleys 107, where an endless belt 108, to which the round blade carriage 103 is attached, is stretched between the two pulleys 107. The pulley 107 is caused to rotate by the drive of the round blade carriage motor 39, where in conjunction with a rotation of the pulley 107, the round blade carriage 103 attached to the endless belt 108 moves along the width direction B. That is, the movement direction in which the round blade carriage 103 moves corresponds to the width direction B.

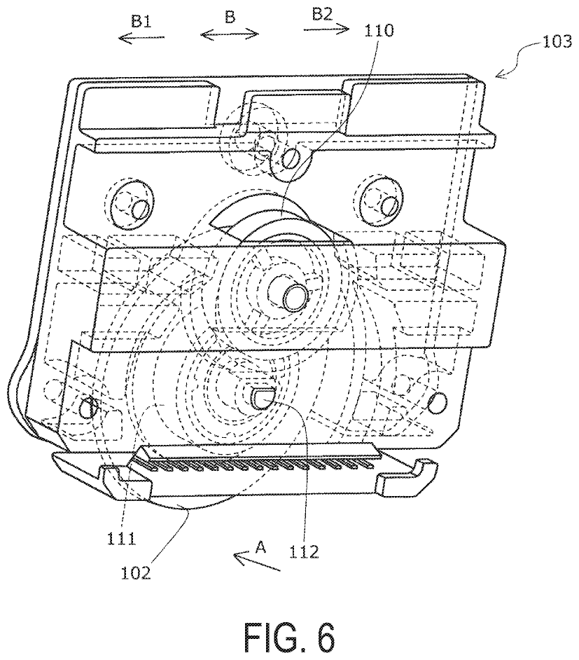

In addition, as illustrated in FIGS. 3 and 4, the frame 104 is provided with a rack 109 that also serves as a guide portion for guiding a movement of the round blade carriage 103 along the width direction B. On the other hand, as illustrated in FIGS. 3, 5, and 6, the round blade carriage 103 is provided with a pinion 110 that engages with the rack 109. Further, as illustrated in FIGS. 3 and 6, the round blade carriage 103 includes a gear 111 that engages with the pinion 110, where the gear 111 is fixed to the round blade 102 with the round blade 102 and a rotary shaft 112 being in common. The cutter unit 100, which is configured as such, is configured in which the round blade 102 automatically rotates in conjunction with causing the round blade carriage 103 to move along the width direction B.

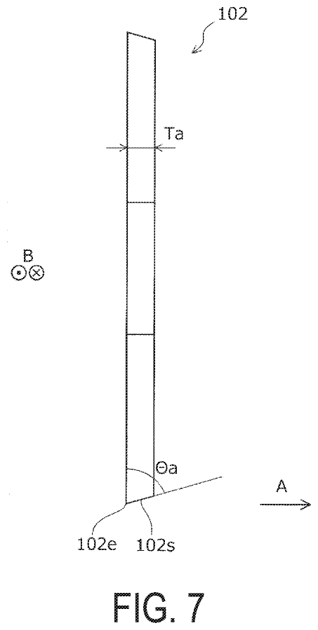

Here, a rake angle Θa of the round blade 102 illustrated in FIG. 7 is set to 77.5±2.5 degrees. When the rake angle Θa becomes not less than 70 degrees, a contact area between the medium M and a rake face 102s of the round blade 102 is enlarged, making it possible to effectively press the medium M toward a direction opposite to a movement direction in which the round blade 102 moves, in a tangential direction at a contact point between the round blade 102 and the medium M. In addition, a thickness Ta of the round blade 102 is set to 1.17±0.03 mm. When the thickness Ta of the round blade 102 becomes not less than 1 mm, the contact area between the medium M and the rake face 102s of the round blade 102 is enlarged, and the medium M can be effectively pressed toward a direction opposite to the movement direction in which the round blade 102 moves, in the tangential direction at the contact point between the round blade 102 and the medium M.

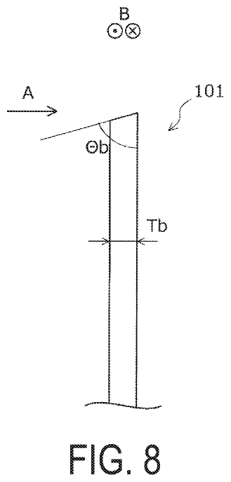

On the other hand, the rake angle Θb of the fixed blade 101 illustrated in FIG. 8 is set to 77.5±2.5 degrees. When the rake angle Θb becomes not less than 70 degrees, the medium M can be effectively pressed toward the direction opposite to the movement direction in which the round blade 102 moves, in the tangential direction at the contact point between the round blade 102 and the medium M. In addition, a thickness Tb of the fixed blade 101 is set to 1.17±0.03 mm. When the thickness Tb of the fixed blade 101 becomes not less than 1 mm, the medium M can be effectively pressed toward the direction opposite to the movement direction in which the round blade 102 moves, in the tangential direction at the contact point between the round blade 102 and the medium M.

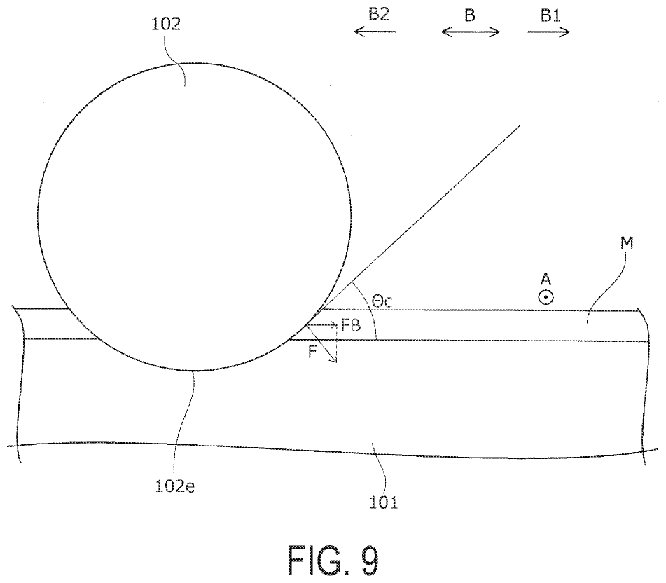

Here, as illustrated in FIG. 9, a force FB applied in the width direction B to the medium M in conjunction with cutting the medium M by causing the round blade 102 to move to a first direction B1 of the width direction B relative to the fixed blade 101 coincides with a force equivalent to a vector in a direction along the width direction B of a force F applied from the round blade 102 to the medium M. A cutter device for cutting the medium M by causing the round blade 102 to move relative to the fixed blade 101, such as the printing apparatus 1 of the example, has a tendency that a cutting angle Θc increases, as illustrated in FIG. 9. This is because a blade edge 102e of the round blade 102 is arranged in an arc shape rather than in a straight line shape. Accordingly, in the cutter device for cutting the medium M by causing the round blade 102 to move relative to the fixed blade 101, such as the printing apparatus 1 of the example, the force FB increases which is applied to the medium M in conjunction with causing the round blade 102 to move in the width direction B relative to the fixed blade 101 to cut the medium M.

Note that, as illustrated in FIG. 9, the round blade 102 partially faces the fixed blade 101 in a front view when viewed from a direction of the rotary shaft 112 of the round blade 102. Then, the round blade 102 is disposed in a manner inclined, rather than in parallel, relative to the fixed blade 101 such that the round blade 102 comes in contact with the fixed blade 101 at one point at a position at which the round blade 102 faces the fixed blade 101. The round blade 102 is also configured to be pressed against the fixed blade 101 at the one point by a biasing portion provided in the round blade carriage 103. The cutter unit 100 of the example, which has such a configuration, has a high cutting capability of the medium.

Next, a drive of the printing apparatus 1 of the example related to a drive of the cutter unit 100 will be described with reference to FIGS. 10 and 11. Specifically, the drive of the printing apparatus 1 described below is a drive for causing the control of the controller 30 to drive the roller pair 2 and the cutter unit 100, to cut the medium M.

FIG. 10 illustrates a state where the medium M is transported to a cutting position of the cutter unit 100, which is a state of immediately before cutting the medium M. In FIG. 10, the round blade carriage 103 is located at a home position, and moves to the first direction B1 of the width direction B when cutting the medium M. Note that a rotation direction in which the round blade 102 rotates when the round blade carriage 103 moves to the first direction B1 coincides with a rotation direction R1. In other words, in the printing apparatus 1 of the example, the rotation direction R1 in which the round blade 102 rotates when the medium is cut M by causing the round blade 102 to move to the first direction B1 is the same direction as the first direction B1, which is the movement direction in which the round blade 102 moves. That is, when the round blade 102 moves, for example, to the right direction, the rotation direction in which the round blade 102 rotates coincides with the right (clockwise) direction.

FIG. 11 illustrates a state immediately after the round blade carriage 103 moves to the first direction B1 from the state in FIG. 10 to cut the medium M. In FIG. 11 the round blade carriage 103 is located on a side opposite in the width direction B from the home position, and after this state, the round blade carriage 103 moves to a second direction B2 that is a direction opposite to the first direction B1, and returns to the home position. Note that the rotation direction in which the round blade 102 rotates when the round blade carriage 103 moves to the second direction B2 coincides with a rotation direction R2 that is a direction opposite to the rotation direction R1.

Here, to once summarize, the printing apparatus 1 of the example includes the roller pair 2 serving as a transport unit of the medium M, the head 4 serving as a printing unit for performing printing on the medium M, the round blade 102 configured to move in the width direction B while rotating, the round blade 102 having a thickness of not less than 1 mm and a rake angle of not less than 70 degrees, and the fixed blade 101 provided along the width direction B. In addition, the rotation direction R1 in which the round blade 102 rotates when the medium is cut M by causing the round blade 102 to move to the first direction B1 of the width direction B coincides with the first direction B1.

Here, in the printing apparatus 1 of the example, a rotational speed at which the round blade 102 rotates when the medium is cut M by causing the round blade 102 to move to the first direction B1 is set greater than a speed at which the round blade 102 is caused to move to the first direction B1. To paraphrase the above description, a movement distance in which the round blade carriage 103 moves per unit time to the first direction B1 is greater than a movement distance in which the blade edge 102e moves per unit time in the rotation direction in which the round blade 102 rotates.

That is, in the printing apparatus 1 of the example, the round blade 102 is caused to rotate to have a force applied to the medium M in the rotation direction in which the round blade 102 rotates, and the rotational speed at which the round blade 102 rotates is made to coincide with a rotational speed at which the medium M is drawn toward the round blade 102 at a speed that is greater than a speed at which the medium M is pushed in the movement direction in which the round blade 102 moves in conjunction with a movement of the round blade 102. Then, because the round blade 102 has a thickness of not less than 1 mm or a rake angle of not less than 70 degrees, a contact area between the round blade 102 and the medium M is made enlarged, making it possible to sufficiently strengthen a force applied in a direction opposite to a force pressing the medium M in the movement direction in which the round blade 102 moves. This allows the printing apparatus 1 of the example, at the time when causing the round blade 102 to move relative to the fixed blade 101 to cut the medium M, to suppress the position of the medium M from being displaced due to the medium M being pressed in the movement direction in which the round blade 102 moves. Thus, the printing apparatus 1 of the example can suppress an image from being printed at a position displaced from a desired position on the medium M.

To summarize the above description from the perspective of the cutter device, the cutter device of the example includes the roller pair 2 serving as a transport unit of the medium M, the round blade 102 configured to move in the width direction B while rotating, the round blade 102 having a thickness of not less than 1 mm and a rake angle of not less than 70 degrees, and the fixed blade 101 provided along the width direction B. In addition, the rotation direction R1 in which the round blade 102 rotates when the medium is cut M by causing the round blade 102 to move to the first direction B1 of the width direction B coincides with the first direction B1. Then, the rotational speed at which the round blade 102 rotates when the medium is cut M by causing the round blade 102 to move to the first direction B1 is set greater than the speed at which the round blade 102 is caused to move to the first direction B1. This allows the cutter device of the example, at the time when causing the round blade 102 to move relative to the fixed blade 101 to cut the medium M, to suppress the position of the medium M from being displaced due to the medium M being pressed in the movement direction in which the round blade 102 moves.

In addition, as described above, in the printing apparatus 1 of the example, the fixed blade 101 has a thickness of not less than 1 mm and a rake angle of not less than 70 degrees. By setting the thickness of the fixed blade 101 to not less than 1 mm or the rake angle of the fixed blade 101 to not less than 70 degrees, the medium M can be effectively pressed toward the direction opposite to the movement direction in which the round blade 102 moves, in the tangential direction at the contact point between the round blade 102 and the medium M. This allows the printing apparatus 1 according to the example, when the round blade 102 is caused to move relative to the fixed blade 101 to cut the medium M, to suppress, in a particularly efficient manner, the position of the medium M from being displaced due to the medium M being pressed in the movement direction in which the round blade 102 moves.

Note that the disclosure is not limited to the aforementioned examples and many variations are possible within the scope of the disclosure as described in the appended claims. It goes without saying that such variations also fall within the scope of the disclosure.

What is claimed is:

1. A cutter device comprising:
a transport unit for transporting a medium;
a round blade configured to move, while rotating, in a width direction intersecting a transport direction in which the medium is transported; and
a fixed blade provided along the width direction, wherein
a rotation direction in which the round blade rotates when the medium is cut by causing the round blade to move to a first direction of the width direction coincides with the first direction,
a rotational speed at which the round blade rotates when the medium is cut by causing the round blade to move to the first direction is set greater than a speed at which the round blade is caused to move to the first direction, and
a thickness of the round blade is not less than 1 mm.

2. A cutter device comprising:
a transport unit for transporting a medium;
a round blade configured to move, while rotating, in a width direction intersecting a transport direction in which the medium is transported; and
a fixed blade provided along the width direction, wherein
a rotation direction in which the round blade rotates when the medium is cut by causing the round blade to move to a first direction in the width direction coincides with the first direction,
a rotation speed at which the round blade rotates when the medium is cut by causing the round blade to move to the first direction is set greater than a speed at which the round blade is caused to move to the first direction, and
a rake angle of the round blade is not less than 70 degrees.

3. The cutter device according to claim 2, wherein
a thickness of the round blade is not less than 1 mm.

4. The cutter device according to claim 1, wherein
a thickness of the fixed blade is not less than 1 mm.

5. The cutter device according to claim 1, wherein
a rake angle of the fixed blade is not less than 70 degrees.

6. A printing apparatus comprising:
a transport unit for transporting a medium;
a printing unit configured to perform printing on the medium;
a round blade configured to move, while rotating, in a width direction intersecting a transport direction in which the medium is transported; and
a fixed blade provided along the width direction, wherein
a rotation direction in which the round blade rotates when the medium is cut by causing the round blade to move to a first direction of the width direction coincides with the first direction,
a rotational speed at which the round blade rotates when the medium is cut by causing the round blade to move to the first direction is set greater than a speed at which the round blade is caused to move to the first direction, and
a thickness of the round blade is not less than 1 mm.

7. A printing apparatus comprising:
a transport unit for transporting a medium;
a printing unit configured to perform printing on the medium;
a round blade configured to move, while rotating, in a width direction intersecting a transport direction in which the medium is transported; and
a fixed blade provided along the width direction, wherein
a rotation direction in which the round blade rotates when the medium is cut by causing the round blade to move to a first direction of the width direction coincides with the first direction,
a rotation speed at which the round blade rotates when the medium is cut by causing the round blade to move to the first direction is set greater than a speed at which the round blade is caused to move to the first direction, and
a rake angle of the round blade is not less than 70 degrees.
